(19) United States
(12) Patent Application Publication
(10) Pub. No.: US 2017/0249686 A1
(43) Pub. Date: Aug. 31, 2017

(54) SYSTEM, METHOD, AND NON-TRANSITORY COMPUTER-READABLE STORAGE MEDIUM FOR DISPLAYING A HIERARCHY OF CATEGORIES FOR A SEARCH QUERY ON A WEBPAGE

(71) Applicant: Wal-Mart Stores, Inc., Bentonville, AR (US)

(72) Inventors: Zebin Chen, Santa Clara, CA (US); Heather Marie Ku, Foster City, CA (US); Andrei Lopatenko, Cupertino, CA (US); Manas Ashok Pathak, Sunnyvale, CA (US)

(21) Appl. No.: 15/056,820

(22) Filed: Feb. 29, 2016

(51) Int. Cl. G06Q 30/06; G06F 17/30

(52) U.S. Cl. CPC G06Q 30/0629; G06F 17/30867; G06F 17/30864; G06F 17/30601

(57) ABSTRACT

A system, method, and computer-readable medium are disclosed that include a database, a website hosting module, a search engine module, and a category display module. The database stores a hierarchy of categories for categorizing products for sale and product records associated with the hierarchy. A search query is received from a user device and a list of product records responsive to the search query is received. A list of dominant records is identified for the product records and a number of top-level categories is identified for the dominant records. A modified hierarchy of categories is identified based on the number of top-level categories and the modified hierarchy is displayed in a navigation portion of a webpage and is usable to filter the list of product records responsive to the search query.

### FIELD OF THE DISCLOSURE

The present disclosure relates generally to a system, method, and non-transitory computer-readable storage medium for displaying a hierarchy of categories for a search query on a webpage.

### BACKGROUND

At least some known web hosting systems include search engines that allow users to enter search criteria (e.g., a search query) and to generate search results based on the user's search criteria. Typically, the search engine generates a list of products or other search results based on the user's search criteria, and the list of results may be displayed to the user, such as on a webpage or through a specially designed application or app resident on a user's computing device.

For many online search engines, the webpage or application offers categorized searching to allow the user to narrow initial search results to a more manageable number of search results, and to include items that are more on-point and meaningful to the user. For instance, the search engine may generate initial search results based on the user's search query entered into the search engine. The initial search results can be narrowed to a more manageable number of search results by selecting one or more categories presented on a left hand navigation (LHN) portion of the webpage.

Since each user and each search query is typically different, one challenge with current online search engines that utilize categorized search results is that selection and ordering of the categories presented on the LHN portion of the webpage have to be individually created and optimized. Another challenge with current online search engines that utilize categorized searching is determining how many categories and what portions of a category hierarchy to actually display on the webpage for a given search query.

The present disclosure is aimed at solving the problems identified above.

### BRIEF SUMMARY

In different embodiments of the present disclosure, systems, methods, and computer-readable storage media allow users to enter a search query into a search engine and automatically display a hierarchy of categories for the user's search query on, e.g., a left hand navigation (LHN) portion of the webpage.

In one embodiment, a system includes a database that stores a hierarchy of categories for categorizing a plurality of products for sale and at least one product record associated with each of the plurality of products, wherein each product record includes at least one associated category from the hierarchy of categories. The system also includes a website hosting module, a search engine module, and a category display module. The website hosting module is configured to present a webpage to a user device and receive a search query from the user device. The search engine module is configured to receive the search query from the website hosting module and identify a list of product records responsive to the search query. The category display module is configured to identify a list of dominant categories based on the product records identified by the search engine module, identify a number of top-level categories associated with the list of dominant categories, construct a modified hierarchy of categories based on the number of top-level categories identified, and transmit the modified hierarchy to the website hosting module to cause the website hosting module to display the modified hierarchy in a navigation portion of the webpage. The modified hierarchy is usable to filter the list of product records responsive to the search query.

In another embodiment, a method includes storing, in a database, a hierarchy of categories for categorizing a plurality of products for sale and at least one product record associated with each of the plurality of products, wherein each product record includes at least one associated category from the hierarchy of categories. The method also includes presenting, by a website hosting module, a webpage to a user device, receiving, by the website hosting module, a search query from the user device, receiving, by a search engine module, the search query from the website hosting module, and identifying, by the search engine module, a list of product records responsive to the search query. The method further includes identifying, by a category display module, a list of dominant categories based on the product records identified by the search engine module, identifying, by the category display module, a number of top-level categories associated with the list of dominant categories, constructing, by the category display module, a modified hierarchy of categories based on the number of top-level categories identified, transmitting, by the category display module, the modified hierarchy to the website hosting module, and displaying, by the website hosting module, the modified hierarchy in a navigation portion of the webpage, wherein the modified hierarchy is usable to filter the list of product records responsive to the search query.

In yet another embodiment, a non-transitory computer-readable medium includes instructions that, when executed by a processor, cause the processor to store, in a database, a hierarchy of categories for categorizing a plurality of products for sale and at least one product record associated with each of the plurality of products, wherein each product record includes at least one associated category from the hierarchy of categories. The instructions also cause the processor to present, by a website hosting module, a webpage to a user device, receive, by the website hosting module, a search query from the user device, receive, by a search engine module, the search query from the website hosting module, and identify, by the search engine module, a list of product records responsive to the search query. The instructions also cause the processor to identify, by a category display module, a list of dominant categories based on the product records identified by the search engine module, identify, by the category display module, a number of top-level categories associated with the list of dominant categories, construct, by the category display module, a modified hierarchy of categories based on the number of top-level categories identified, transmit, by the category display module, the modified hierarchy to the website hosting module, and display, by the website hosting module, the modified hierarchy in a navigation portion of the webpage, wherein the modified hierarchy is usable to filter the list of product records responsive to the search query.

### BRIEF DESCRIPTION OF THE DRAWINGS

Non-limiting and non-exhaustive embodiments of the present disclosure are described with reference to the following figures. Other advantages of the present disclosure will be readily apparent, as the same becomes better understood by reference to the following detailed description when considered in connection with the accompanying drawings wherein:

FIG. 1 is a schematic illustrating various aspects of a system, according to the present disclosure.

FIG. 2 is a schematic illustrating example components of a server that may be used with the system shown in FIG. 1.

FIGS. 3A and 3B are screenshots of an example product hierarchy that may be used with the system shown in FIG. 1.

FIG. 4 is a flow diagram of an example method that may be used with the system shown in FIG. 1.

FIG. 5 is a flow diagram of an example method that may be used with the system shown in FIG. 1 and the method shown in FIG. 4.

FIG. 6 is an example of a screenshot of a search results webpage that may be presented by the system of FIG. 1.

FIG. 7 is another example of a screenshot of a search results webpage that may be presented by the system of FIG. 1.

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements in the figures may be exaggerated relative to other elements to help improve the understanding of various embodiments of the present disclosure. Also, common but well-understood elements that are not useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present disclosure. It will be apparent, however, to one having ordinary skill in the art that the specific detail need not be employed to practice the present disclosure. In other instances, well-known materials or methods have not been described in detail in order to avoid obscuring the present disclosure.

Reference throughout this specification to “one embodiment”, “an embodiment”, “one example” or “an example” means that a particular feature, structure or characteristic described in connection with the embodiment of example is included in at least one embodiment of the present disclosure. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments and/or examples in accordance with the present disclosure may be embodied as an apparatus, method, or computer program product. Accordingly, the present disclosure may take the form of an entirely hardware embodiment, an entirely software embodiment (including firmware, resident software, micro-code, etc.), or an embodiment combining software and hardware aspects that may all generally be referred to herein as a “module” or “system”. Furthermore, the present disclosure may take the form of a computer program product embodied in any tangible media or expression having computer-usable program code embodied in the media.

Any combination of one or more non-transitory computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisional via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart(s) and block diagram(s) in the flow diagram(s) illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “connected”, “in communication with” or “configured to be in communication with”. This terminology is intended to be non-limiting, and where appropriate, be interpreted to include without limitation, wired and wireless communication using any one or a plurality of suitable protocols, as well as communication methods that are constantly maintained, are made on a periodic basis, and/or made or initiated on an as needed basis. The term “coupled” means connected by any suitable communications link, including but not limited to the Internet, a LAN, a cellular network, or any suitable communications link. The communications link may include one or more of a wired and wireless connection and may always be connected, connected on a periodic basis, and/or connected on an as needed basis.

Embodiments of the present disclosure particularly describe how to optimize and select an arrangement of product categories for display on a webpage of an online shopping service for a given search query. The present disclosure utilizes a computer program to dynamically select the arrangement (particularly, a selection and ordering) of categories for a given search query entered into a search engine of the online shopping service or another suitable online search page.

In one embodiment, a database stores a plurality of product records for a plurality of products offered for sale on a webpage of an online shopping website. A user enters a search query on the webpage related to one or more products the user wishes to find. A search engine module receives the search query and identifies one or more search results that are responsive to the search query, including, for example, one or more products and associated product records.

A category display module receives the search results and identifies a list of dominant categories based on the product records identified by the search engine. The category display module also identifies a number of top-level categories or departments associated with the dominant categories by referencing hierarchy data in the product records stored in the database. A modified hierarchy of categories is constructed based on the hierarchy or hierarchy data stored in the database and based on the number of top-level categories identified.

In one embodiment, if the number of top-level categories is greater than a predetermined threshold, sibling categories of the dominant categories are identified and promoted to become dominant categories themselves if a category score of the sibling category is equal to or greater than a relaxed threshold. All intermediate ancestor categories of the dominant categories within the hierarchy (i.e., all ancestor categories located within the hierarchy between the dominant categories and the top-level categories) are removed and the top-level categories or departments associated with the dominant categories are added to the modified hierarchy if not already present.

In one embodiment, if the number of top-level categories is less than or equal to a predetermined threshold, sibling categories of the dominant categories are identified and promoted to become dominant categories themselves if the category score of the sibling category is equal to or greater than the relaxed threshold. All intermediate ancestor categories of the dominant categories within the hierarchy are removed. One or more common ancestor categories of the dominant categories are identified and added to the hierarchy along with the top-level categories or departments associated with the dominant categories and the common ancestor categories.

The modified hierarchy is then transmitted to the website hosting module to cause the website hosting module to display the modified hierarchy in a left-hand navigation portion of the webpage (or another suitable location of the webpage). The user can then use the modified hierarchy to filter the list of products responsive to the search query. In such a manner, an optimal number of categories and levels of categories is provided to the user in response to the search query. The display of categories is thus designed to strike an optimal balance between providing the user with the most relevant hierarchical categories while minimizing the amount of space used to display the categories. In such a manner, the display and categorization of the search results is improved which is particularly beneficial to mobile users who may have a much more space-constrained display screen than users of desktop or laptop computers.

Display of the optimal arrangement of categories for a given search query on, e.g., the left-hand navigation (LHN) portion of the webpage allows a user (such as a consumer) to easily and efficiently navigate through many (e.g., tens, hundreds, or even thousands) products in order to locate a particular product. Easy and efficient navigation through the products increases product engagement and, therefore, increases the likelihood that the consumer will purchase the product. This, in effect, can increase revenue for the online shopping service.

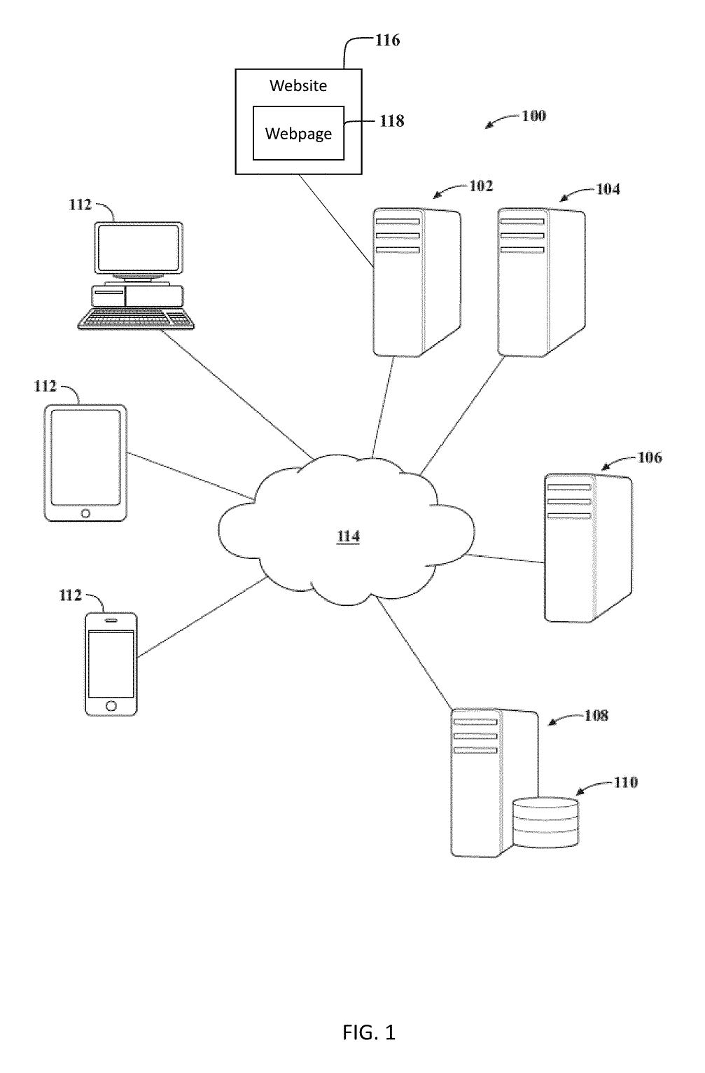

FIG. 1 is a schematic diagram of an example system 100 that may be used to implement an online shopping service. In the illustrated embodiment, the system 100 is configured to enable a user to access a website with one or more user computing devices to view information indicative of products that may be purchased by the user via the website. The system 100 generates and displays, on the LHN portion of a webpage of the online shopping service, selected categories which are specifically selected for a given search request.

In the illustrated embodiment, the system 100 includes a website host server 102, a search engine server 104, a sorting server 106, a database server 108, a database 110, and one or more user computing devices 112 each coupled in communication via a communications network 114. The communications network 114 may be any suitable connection, including the Internet, file transfer protocol (FTP), an Intranet, LAN, a virtual private network (VPN), cellular networks, etc. Further, the communications network 114 may utilize any suitable or combination of technologies including, but not limited to, wired and wireless connections, always on connections, connections made periodically, and connections made as needed.

The user computing device 112 may include any suitable device that enables a user to access and communicate with the system 100 including sending and/or receiving information to and from the system 100 and displaying information received from the system 100 to a user. For example, and in one embodiment, the user computing device 112 may include, but is not limited to, a desktop computer, a laptop or notebook computer, a tablet computer, a smartphone/tablet computer hybrid, a personal data assistant, a handheld mobile device including a cellular telephone, and the like.

The database server 108 is connected to the database 110 to retrieve and store information contained in the database 110. The database 110 contains, for example, information pertaining to webpages associated with one or more websites, customer account information, product records, and/or any suitable information that enables the system 100 to function as described herein. The database 110 further contains information pertaining to the categories to be displayed on a left hand navigation portion of the webpage.

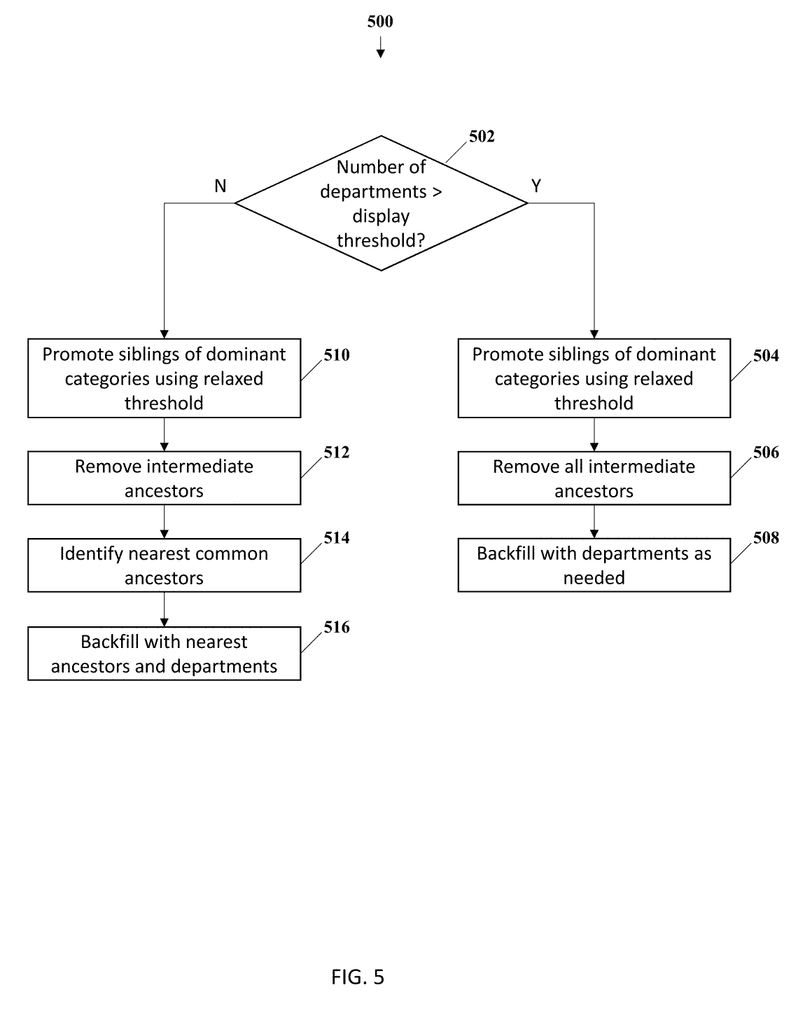

The website host server 102 is configured to host a website 116 (an example of which is shown in FIG. 5) that is accessible by a user via one or more user computing devices 112. The website host server 102 retrieves and stores webpages 118 associated with one or more websites 116 in response to requests received from the user via the user computing device 112. The webpages 118 allow users to interact with the website 116 and search and/or purchase products such as, for example, goods and/or services via the website 116. In one embodiment, the website host server 102 is configured to generate and display webpages 118 associated with the website 116 in response to requests being received from consumers via corresponding web browsers that are displayed on the user computing devices 112. For example, the website hosting server 102 may display a product search webpage 116 in response to receiving a user request that allows a user to input a product search request or query including search criteria with one or more search terms. In addition, the website host server 102 may transmit the product search request to the search engine server 104 and/or the sorting server 106 for use in generating search data (such as a plurality of product records) in response to the user's search query. The web site host server 102 may also receive product record(s) from the search engine server 104 and/or the sorting server 106 that includes information associated with each of the product records selected based on the user's search query. The website host server 102 may also display a search results webpage to display the product records to the user and to allow the user to select one or more of the products associated with the product records for purchase.

The search engine server 104 is configured to receive a product search query from the website host server 102 including one or more search terms and to generate search data including a plurality of product records as a function of the search terms. For example, the search engine server 104 may initiate a search algorithm based on a Boolean model or another suitable model to search product records contained in the database 110 based on the search terms set forth in the user's product search query.

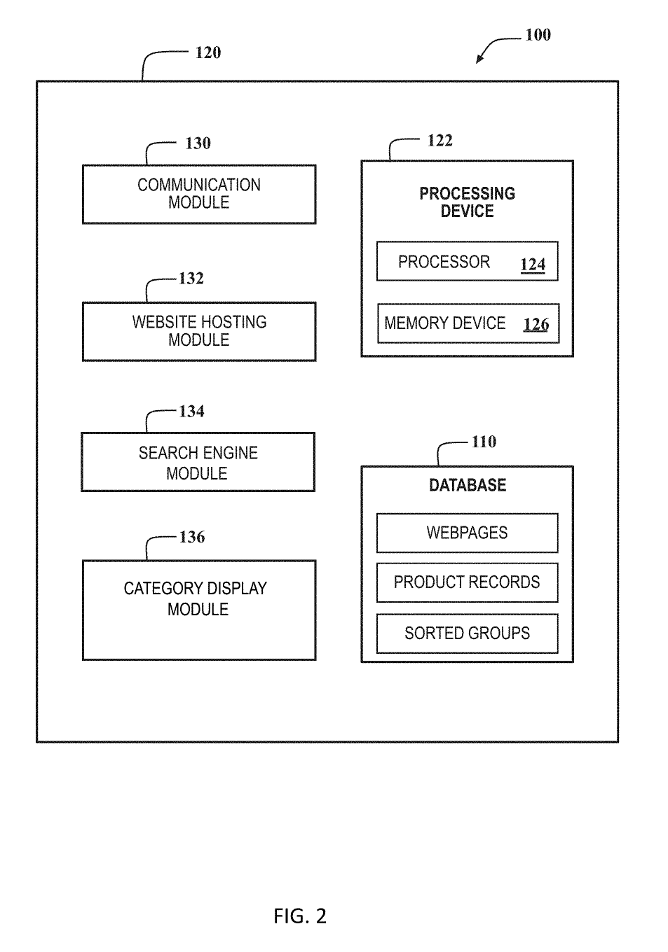

Referring to FIG. 2, and in an embodiment, the system 100 may include a system server 120 configured to perform the functions of the website host server 102, the search engine server 104, the sorting server 106, and the database server 108. As shown, the system server 120 includes a processing device 122 and the database 110. Alternatively, one or more of the website host server 102, the search engine server 104, the sorting server 106, and the database server 108 may be separate from the system server 120 and may include a respective processing device 122 and/or database 110.

The processing device 122 executes various programs, and thereby controls components of the system server 120 according to user instructions received from the user computing device 112. The processing device 122 may include a processor or a plurality of processors 124 and a memory device 126. The processor(s) 124 may be a controller, a microcontroller, a microprocessor, an application specific integrated circuit (ASIC), or a processor working in conjunction with a central processing unit (CPU) performing the function of a general purpose computer. The processor 124 is configured to execute computer programs containing computer-readable and executable instructions for performing one or more steps of the methods described herein.

The memory device 126 may include a read only memory (ROM) and random access memory (RAM) for storing the computer-readable instructions for performing the steps of the methods described herein. In embodiments where the processing device 122 includes two or more processors 124, the processors 124 can operate in parallel or distributed manner. In an example, the processing device 122 may execute various modules of the system 100.

The memory device 126 may be configured to store programs and information in the database 110, and retrieving information from the database 110 that may be used by the processor 124 to perform various functions described herein. The memory device 126 may include, but is not limited, to a hard disc drive, an optical disc drive, and/or a flash memory drive. Further, the memory device 126 may be distributed and located at multiple locations.

The communications module 130 retrieves various data and information from the database 110 and sends information to the user computing device 112 via the communications network 114 to enable the user to access and interact with the system 100. In an embodiment, the communications module 130 displays various images on a graphical user interface of the user computing device 112, such as by using computer graphics and image data stored in the database 110 including, but not limited to, webpages, product records, sorted groups, product lists, and/or any suitable information and/or images that enable the system 100 to function as described herein.

The website hosting module 132 may be programmed to perform some or all of the functions of the website host server 102 including hosting various webpages associated with one or more websites that are stored in the database 110 and that are accessible to the user via the user computing device 112. The website hosting module 132 may be programmed to generate and display webpages associated with a website in response to requests being received from users via corresponding web browsers.

The search engine module 134 may be programmed to perform some or all of the functions of the search engine server 104 including generating and storing search data in response to the user's product search request (e.g., the user's search query).

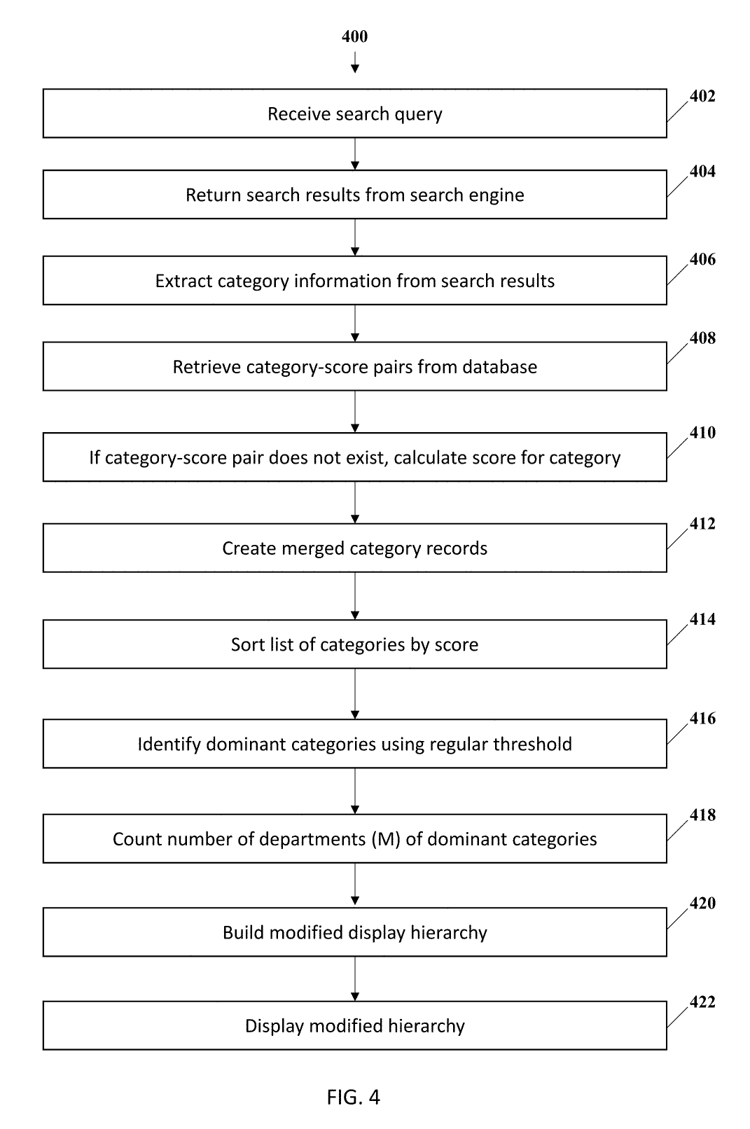

The system 100 also includes a category display module 136. The category display module 136 identifies a list of dominant categories of products based on the search results returned by the search engine module 134. The category display module 136 builds a hierarchy of categories including the dominant categories to be displayed to the user for filtering the search results. The methods by which the category display module 136 identifies and builds the hierarchy of categories are described in detail below with reference to FIGS. 4 and 5. In one embodiment, the category display module 136 may be implemented by the sorting server 106 and may perform the functions of the sorting server 106.

In one embodiment, the database 110 collects and stores data from a plurality of search queries that have been conducted in the past. For example, data may be collected for each search query entered into the search engine module 134, including category clicks (i.e., a number of times a category was clicked on or selected by users in past searches), category impressions (i.e., a number of times a category was presented to the users in past searches), and item or product clicks (i.e., a number of times the item or product was clicked on or selected by users in past searches). The category clicks from previous search queries may be stored in the database 110 as a category click history and the category impressions from previous search queries may be stored in the database 110 as a category impression history (or category show history). Further, item or product clicks from previous search queries may be stored in the database 110 as an item click history.

In an embodiment, the database 110 may also store tables or product records which map particular items or products to one or more product categories. For instance, the tables or records may be constructed, by the processing device 122, by tracking the category click history, category show history, and item click history during each search query session. This mapping of products to product categories may be accomplished by a query categorization algorithm or process. The mapping of the products to product categories also involves the calculation and assignment of a score to the category which represents how likely a user is to click on the category when searching for an associated query term. The score may be a popularity score that represents how often that particular category was clicked on by users who searched for the query term (or related terms). In one example, the search engine module 134 may compute the popularity score to be the number of times the category was clicked divided by the number of times the category was shown to the user for a particular search query term or terms. Alternatively, any other suitable calculation may be used to compute the popularity score.

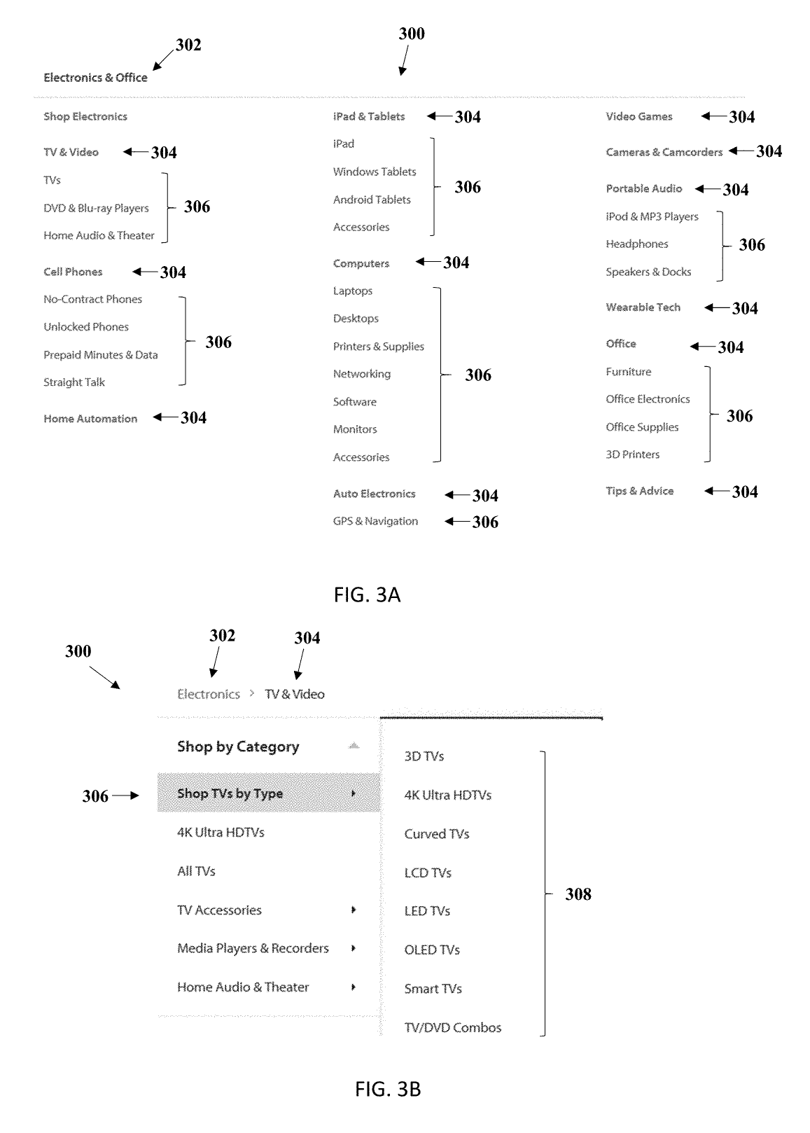

FIGS. 3A and 3B are screenshots of an example category hierarchy 300 that may be used with system 100. While FIGS. 3A and 3B illustrate a hierarchy of categories that may be used to categorize products offered for sale on an online website, it should be recognized that the categories may be used to categorize services or any other type of items or data.

In one embodiment, hierarchy 300 is stored in database 110 in the form of a sorted group or list of category records. Each category record may identify an associated category and data related to the position of the category in the hierarchy 300. The position data may include, for example, a parent category, one or more additional intermediate ancestor categories, a child category, a top-level category (sometimes referred to herein as a “department” or “department category”), and one or more sibling categories. The category records may be associated with, or included within, the relevant product records.

As used herein, the term “ancestor category” refers to a category that is one or more levels up in the hierarchy as compared to the category being referenced and that is within the direct parent-child chain from the category being referenced. An “intermediate category” or “intermediate ancestor category” refers to an ancestor category that is at a position in the hierarchy 300 that is higher than the category being referenced but lower than a top-level category (such as a department) that encompasses the category being referenced.

In the example illustrated in FIG. 3A, a portion of an example hierarchy 300 shows a top-level category or department 302 (sometimes referred to as a first level of the hierarchy) of “Electronics & Office”. The department 302 includes a first intermediate level 304 (sometimes referred to as a second level of the hierarchy) including a plurality of child categories including “TV & Video”, “Cell Phones”, Computers”, etc. FIG. 3B illustrates another portion of the hierarchy 300, specifically, a second intermediate level 306 showing child categories of the TV & Video category. The lowest level 308 of the hierarchy 300 includes the categories of “3D TVs”, “4K Ultra HDTVs”, “Curved TVs”, etc. which are sometimes referred to as leaf categories. Accordingly, referring to the lowest level category of “3D TVs”, ancestor categories include “Shop TVs by Type”, “TV & Video”, and “Electronics & Office”. Intermediate categories between “3D TVs” and the department of “Electronics & Office” include “Shop TVs by Type” and “TV & Video”. Sibling categories of “3D TVs” include “4K Ultra TVs”, “Curved TVs”, “LCD TVs”, “LED TVs”, “OLED TVs”, “Smart TVs”, and “TV/DVD Combos”. It should be recognized that these examples are merely illustrative, and any suitable hierarchy and categories may be used.

FIG. 4 is a flow diagram of an example method 400 of displaying an optimal group of categories in response to a search query. Method 400 may be executed by one or more processing devices 122 of system 100.

A user may operate a user computing device 112 to access a website 116 and associated webpage 118 through a browser, for example. The user may then enter a search query related to one or more products the user wants to purchase. The search query is received 402 by website hosting module 132 and is forwarded to search engine module 134 for processing.

The search engine module 134 returns 404 a list of search results responsive to the search query to category display module 136, including a list of product records that are associated with, or relevant to, the search results. The search results may also include category information including one or more categories for the product records, such as categories of hierarchy 300 described above with reference to FIG. 3, as well as a count or number of products in each category. Category display module 136 extracts 406 the category information from the search results. Each category and the associated count of products may be stored and processed as one of a plurality of category-count pairs or records for the search query.

A list of category-score pairs related to the search query is retrieved 408 from a cache, such as database 110 (shown in FIG. 2). In one embodiment, database 110 stores a category score for each category related to popular search queries as a category-score pair. The category score may identify how relevant each category is expected to be to the associated search query. For example, the search engine module 134 or another suitable module may compute the category score to be a popularity score for the categories identified as being relevant to the search query terms based on a historical number of clicks or selections by users of the categories and products in the categories for a particular search query. Alternatively, any other suitable method can be used to calculate the category score.

If no category-score pair exists for the search query (e.g., if the search query is not used often), a category score may be calculated 410 by category display module 136 for each category based on a ranking of the products within the category. In one embodiment, the category score may be calculated as the sum of a product ranking score of each product to be displayed on the search results page that is associated with the category. The product ranking score for a product may be calculated to be equal to the number of products to be displayed on a search results webpage (C) minus the position the product will occupy in the list of search results on the webpage (P, where 1<=P<=C). In a specific embodiment, the category score may be calculated according to Equation 1:

Category score=Σₙ₌₁^{C}C−Pₙ Eq. 1

where Pₙ is equal to C if the position n corresponds to a product that is not within the category. Accordingly, only the product ranking scores of the products associated with a category are included in the category score for that category.

A merged category record is created 412 for each category associated with the search results by category display module 136. The merged category record is formed by merging the category-count pair or record received from the search engine module 134 and the category-score pair or record received from the database 110. The merged category record may be a category-score-count record that identifies the category, the category score, and the count of products for the category. If no category score is associated with the merged category record, the category score may be set to 0 for that category record. The merged category records may be organized as a list of category records.

The list of categories or category records is sorted 414 based on the category score, and a list of dominant categories are identified 416 by category display module 136 using a first, or regular, threshold value. The regular threshold may be set to the category score of the Nth category in the sorted list of categories such that the top N categories (or the N categories with the highest category scores) are identified or determined to be dominant categories. A second, or relaxed, threshold may also be determined for use in identifying or determining additional dominant categories as described more fully below. The relaxed threshold may be set to the category score of the Kth category, where N and K are selectable by the operator of the system to adjust the number of dominant categories to be displayed. In an example embodiment, K=N+2. Alternatively, K may be set to any suitable value greater than or equal to N.

The departments (or top-level categories 302 of the hierarchy 300) are identified by category display module 136 for each dominant category based on the hierarchy 300 and product record data stored in database 110, for example. The total number of departments (M) of the dominant categories is then counted 418 by category display module 136.

A modified display hierarchy is then built or constructed 420 by category display module 136, for example, based on the number M of departments for the dominant categories. Further details of the process or method of building the modified display hierarchy are discussed below in FIG. 5. Once the modified display hierarchy is built, the category display module 136 transmits the modified hierarchy to website hosting module 132 to cause website hosting module 132 to display 422 the modified hierarchy on a left-hand navigation portion of a website presented to the user. The search engine module 134 also provides the list of products (search results) that match or are responsive to the search query in a main navigation pane of the website. The categories of the LHN portion may then be clicked on or otherwise selected by the user to filter the search results shown in the main navigation pane.

FIG. 5 is a flow diagram of an example method 500 of building a modified display hierarchy that may be used with method 400 (shown in FIG. 4). For example, method 500 may be used to implement step 420 of method 400 to build the modified hierarchy described therein. Method 500 may be executed by one or more processing devices 122 of system 100. More specifically, in one embodiment, method 500 is implemented by processing device 122 executing category display module 136 to perform the functions described herein.

It should be recognized that building a modified display hierarchy may be implemented by first copying the hierarchy 300 stored in database 110 and then adding categories to or subtracting categories from the copied hierarchy. Alternatively, building a modified display hierarchy may include identifying portions of the hierarchy 300 to display and portions of the hierarchy 300 to hide or prevent from being displayed on the LHN portion of the search results webpage. Accordingly, steps of method 500 that describe removing portions of the display hierarchy, such as by removing ancestors of dominant categories, may be accomplished by removing the actual portions from the modified display hierarchy or by marking the relevant portions of hierarchy 300 to not be displayed in the resulting category display in the LHN portion of the webpage. Likewise, steps of method 500 that describe adding portions to the display hierarchy, such as by backfilling ancestors or departments of dominant categories, may be accomplished by adding the actual portions to the modified display hierarchy or by marking the relevant portions of hierarchy 300 to be displayed in the resulting category display in the LHN portion of the webpage.

The number of departments (M) of the dominant categories identified above in method 400 is compared 502 to a predetermined display threshold. If M is greater than the predetermined display threshold, (such as a display threshold of 1 in this example), then sibling categories of each dominant category are identified and promoted 504 to become dominant categories themselves if the category score of the respective sibling category exceeds the relaxed threshold K described above with reference to FIG. 4. All intermediate ancestors of the dominant categories (i.e., all ancestor categories except the top-level categories or departments) are then removed 506 and the departments associated with the dominant categories are backfilled 508, or added back into the modified display hierarchy as needed (if they are not already included). Accordingly, in the event that M is greater than the display threshold, the modified display hierarchy only has two hierarchical levels: the top-level departments for the dominant categories, and the lower-level dominant categories themselves.

If M is equal to, or less than the predetermined display threshold (i.e., if M=1 in this example), then sibling categories of each dominant category are identified and promoted 510 to become dominant categories themselves if the category score of the respective sibling category exceeds the relaxed threshold K as described above. All the intermediate ancestors of the dominant categories are then removed 512 in a similar manner as described above. The nearest common ancestors to the lowest-level (or leaf) dominant categories are identified 514 and the departments associated with the nearest common ancestors and dominant categories are backfilled 516, or added back into the modified display hierarchy.

The nearest common ancestors to the lowest-level dominant categories may be identified by first identifying the nearest or shallowest level of the dominant categories in the modified display hierarchy with respect to the top-level categories or departments (i.e., the level in the hierarchy corresponding to the dominant category or categories that is closest to the top-level category). Starting at this shallowest level, the category display module 136 may determine whether there is a single category that is an ancestor to all dominant categories. If so, this category is identified as the nearest common ancestor. If not, the category display module 136 moves up one level in the hierarchy and performs the same determination of whether a single category exists that is an ancestor to all dominant categories. This continues by progressively moving up each level of the hierarchy until a category is found that is an ancestor to all dominant categories. Once that ancestor category is found, the category is identified as the nearest common ancestor to the dominant categories. If no common ancestor category is found by the time the second level of the hierarchy is reached (i.e., the level right below the top-level category or department), then each ancestor of the dominant categories within the second level is identified as a nearest common ancestor category.

The nearest common ancestor or ancestors are then marked as dominant categories and backfilled into the modified display hierarchy. Accordingly, in the event that M is less than or equal to the display threshold, the modified display hierarchy has three hierarchical levels: the top-level departments for the dominant categories and common ancestor(s), the intermediate level for each common ancestor, and the lower-level dominant categories themselves.

The modified display hierarchy is then transmitted to website hosting module 132 to be displayed on the webpage presented to the user along with the search results responsive to the search query as described above with reference to FIG. 4. In one embodiment, the modified display hierarchy is displayed differently depending on the number of departments (M) identified. If M is greater than the display threshold, then all dominant categories of each department are displayed, sorted by category score. If M is less than or equal to the display threshold, each intermediate category of each department (i.e., each nearest common ancestor identified above) is displayed, sorted by category score. Under each intermediate category, each child dominant category is displayed, sorted by category score.

In such a manner, the LHN portion of the webpage can be efficiently filled with an optimal amount of categories and hierarchical levels to achieve a balance between providing the user with relevant categories without cluttering up the space with unnecessary categories or levels.

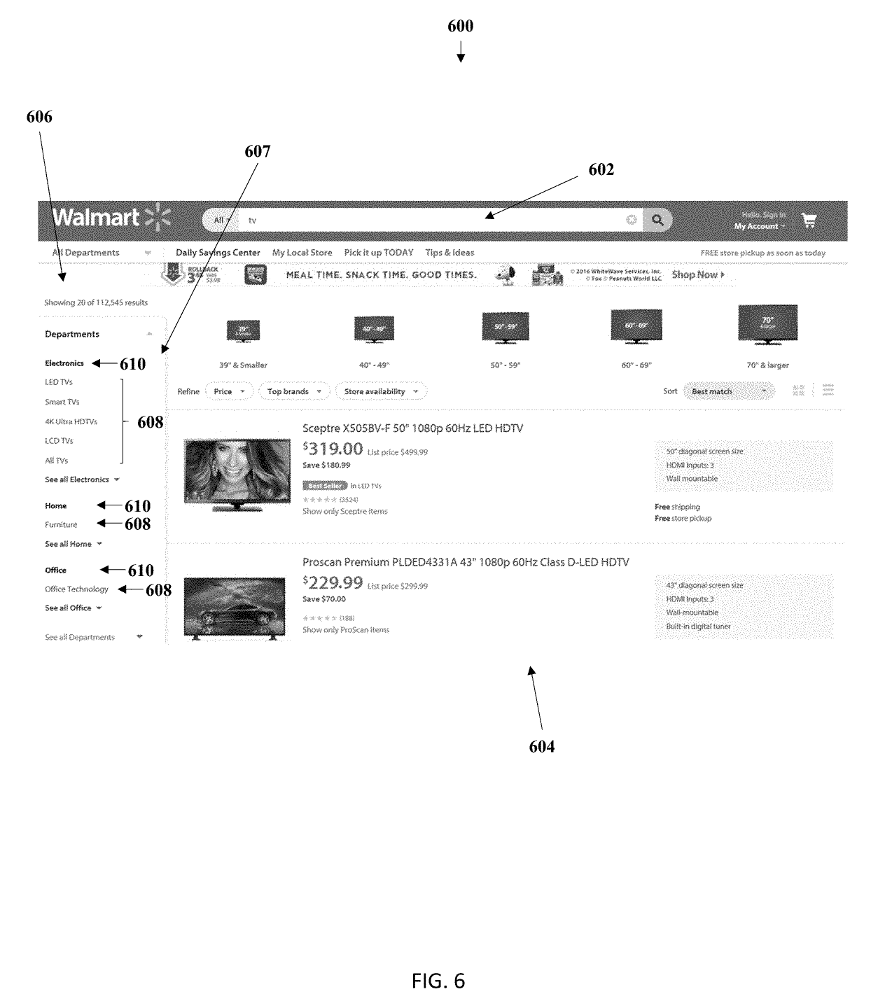

FIG. 6 is a screenshot of a portion of an example search results webpage 600 that may be generated by website hosting module 132 using the methods described herein. In the example shown in FIG. 6, the user has entered a search query of “tv” in a search box 602 at the top of the webpage 600. Responsive to the search query, the search engine module 134 has returned a partial list of products 604 that have been identified as being relevant to the search query. In addition, category display module 136 has provided a modified display hierarchy 606 in the LHN portion 607 of webpage 600. In this example, 5 dominant categories 608 under the department 610 “Electronics” have been identified for the search query, including “LED TVs”, “Smart TVs”, “4k Ultra HDTVs”, “LCD TVs” and “All TVs”. One dominant category 608 (“Furniture”) has been identified under the department 610 “Home”, and one dominant category 608 has been identified under the department 610 “Office”. Since the dominant categories 608 are positioned within three departments 610 (i.e., M=3 where the display threshold=1), only two levels of the hierarchy 606 (top-level departments and lower-level dominant categories) have been provided according to method 500 (shown in FIG. 5). However, it should be recognized that method 500 may provide any suitable number of categories and levels of the hierarchy as desired.

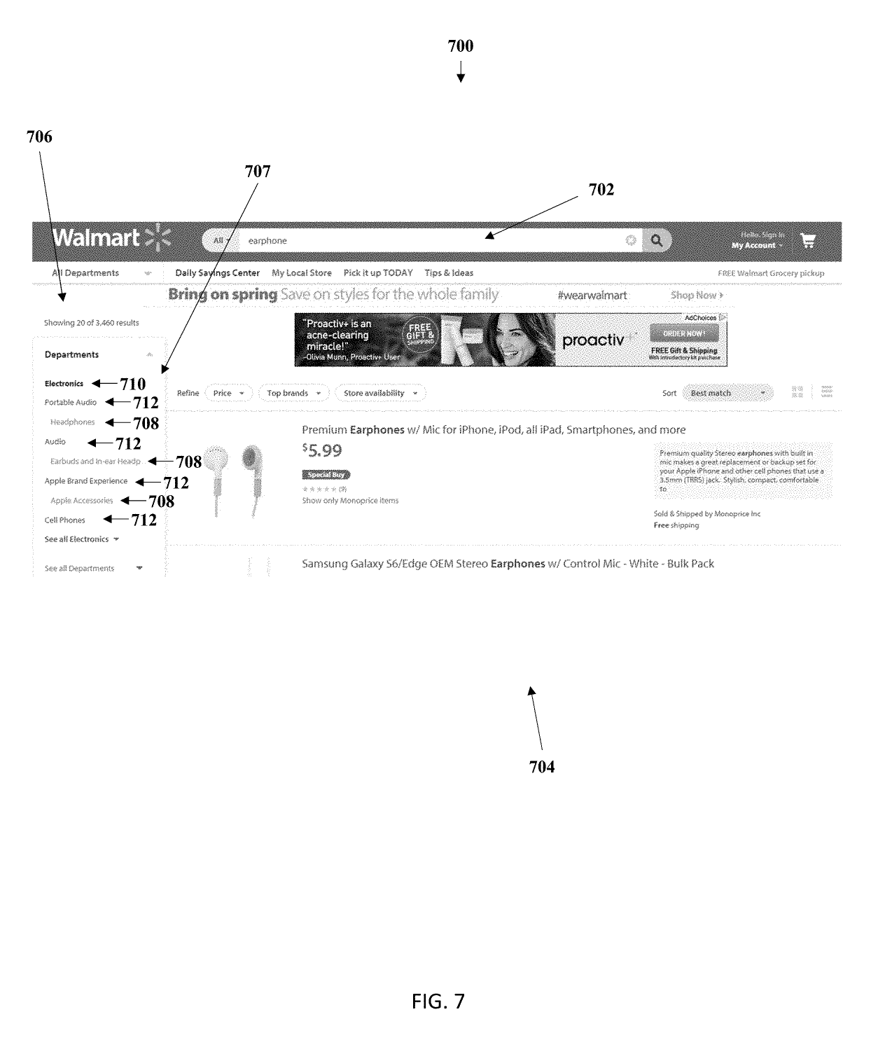

FIG. 7 is a screenshot of another portion of an example search results webpage 700 that may be generated by website hosting module 132 using the methods described herein. In the example shown in FIG. 7, the user has entered a search query of “earphone” in a search box 702 at the top of the webpage 700. Responsive to the search query, the search engine module 134 has returned a partial list of products 704 that have been identified as being relevant to the search query. In addition, category display module 136 has provided a modified display hierarchy 706 in the LHN portion 707 of webpage 700. In this example, 3 dominant categories 708 under the department 710 “Electronics” have been identified for the search query, including “Headphones”, “Earbuds and In-ear Headphones”, and “Apple Accessories”. Since the dominant categories 708 are positioned within only one department 710 (i.e., M=1 where the display threshold=1), three levels of the hierarchy 706 have been provided according to method 500 (shown in FIG. 5), including the top-level department 710, an intermediate level of categories 712 for the common ancestors of the dominant categories 708, and the lower-level dominant categories 708 themselves. However, it should be recognized that method 500 may provide any suitable number of categories and levels of the hierarchy as desired.

The above description of illustrated examples of the present disclosure, including what is described in the Abstract, are not intended to be exhaustive or to be limitation to the precise forms disclosed. While specific embodiments of, and examples for, the disclosure are described herein for illustrative purposes, various equivalent modifications are possible without departing from the broader spirit and scope of the present disclosure.

What is claimed is:

1. A system, comprising:
a database that stores:
a hierarchy of categories for categorizing a plurality of products for sale;
at least one product record associated with each of the plurality of products, wherein each product record includes at least one associated category from the hierarchy of categories;
a website hosting module configured to present a webpage to a user device and receive a search query from the user device;
a search engine module configured to receive the search query from the website hosting module and identify a list of product records responsive to the search query; and
a category display module configured to:
identify a list of dominant categories based on the product records identified by the search engine module;
identify a number of top-level categories associated with the list of dominant categories;
construct a modified hierarchy of categories based on the number of top-level categories identified; and
transmit the modified hierarchy to the website hosting module to cause the website hosting module to display the modified hierarchy in a navigation portion of the webpage, the modified hierarchy usable to filter the list of product records responsive to the search query.

2. The system of claim 1, wherein a product category is associated with each product record of the list of product records, and wherein the category display module determines a category score for each product category and identifies each product category as a dominant category if the category score is greater than or equal to a first threshold.

3. The system of claim 2, wherein the category display module identifies at least one sibling category of a dominant category of the list of dominant categories and promotes the at least one sibling category to a dominant category.

4. The system of claim 3, wherein the category display module determines a category score for the at least one sibling category and promotes the at least one sibling category to a dominant category if the category score exceeds a second threshold that is different than the first threshold.

5. The system of claim 1, wherein the category display module removes from the modified hierarchy all ancestor categories of each dominant category of the list of dominant categories that are positioned between the dominant category and the top-level category of the respective dominant category.

6. The system of claim 1, wherein upon a determination that the number of top-level categories associated with the list of dominant categories is less than or equal to a predetermined display threshold, the category display module identifies at least one common ancestor category of the dominant categories of the list of dominant categories.

7. The system of claim 6, wherein the category display module adds the at least one common ancestor to the modified hierarchy.

8. The system of claim 1, wherein the modified hierarchy includes a first number of hierarchy levels upon a determination that the number of top-level categories associated with the list of dominant categories is less than or equal to a predetermined display threshold, and includes a second number of hierarchy levels upon a determination that the number of top-level categories associated with the list of dominant categories is greater than the predetermined display threshold.

9. A method, comprising:
storing, in a database, a hierarchy of categories for categorizing a plurality of products for sale and at least one product record associated with each of the plurality of products, wherein each product record includes at least one associated category from the hierarchy of categories;
presenting, by a website hosting module, a webpage to a user device;
receiving, by the website hosting module, a search query from the user device;
receiving, by a search engine module, the search query from the website hosting module;
identifying, by the search engine module, a list of product records responsive to the search query;
identifying, by a category display module, a list of dominant categories based on the product records identified by the search engine module;
identifying, by the category display module, a number of top-level categories associated with the list of dominant categories;
constructing, by the category display module, a modified hierarchy of categories based on the number of top-level categories identified;
transmitting, by the category display module, the modified hierarchy to the website hosting module; and
displaying, by the website hosting module, the modified hierarchy in a navigation portion of the webpage, wherein the modified hierarchy is usable to filter the list of product records responsive to the search query.

10. The method of claim 9, wherein a product category is associated with each product record of the list of product records, and wherein the category display module determines a category score for each product category and identifies each product category as a dominant category if the category score is greater than or equal to a first threshold.

11. The method of claim 10, wherein the category display module identifies at least one sibling category of a dominant category of the list of dominant categories and promotes the at least one sibling category to a dominant category.

12. The method of claim 11, wherein the category display module determines a category score for the at least one sibling category and promotes the at least one sibling category to a dominant category if the category score exceeds a second threshold that is different than the first threshold.

13. The method of claim 9, wherein the category display module removes from the modified hierarchy all ancestor categories of each dominant category of the list of dominant categories that are positioned between the dominant category and the top-level category of the respective dominant category.

14. The method of claim 9, wherein upon a determination that the number of top-level categories associated with the list of dominant categories is less than or equal to a predetermined display threshold, the category display module identifies at least one common ancestor category of the dominant categories of the list of dominant categories.

15. The method of claim 14, wherein the category display module adds the at least one common ancestor to the modified hierarchy.

16. The method of claim 9, further comprising including a first number of hierarchy levels in the modified hierarchy upon a determination that the number of top-level categories associated with the list of dominant categories is less than or equal to a predetermined display threshold, and including a second number of hierarchy levels in the modified hierarchy upon a determination that the number of top-level categories associated with the list of dominant categories is greater than the predetermined display threshold.

17. A non-transitory computer-readable medium comprising instructions that, when executed by a processor, cause the processor to:
store, in a database, a hierarchy of categories for categorizing a plurality of products for sale and at least one product record associated with each of the plurality of products, wherein each product record includes at least one associated category from the hierarchy of categories;
present, by a website hosting module, a webpage to a user device;
receive, by the website hosting module, a search query from the user device;
receive, by a search engine module, the search query from the website hosting module;
identify, by the search engine module, a list of product records responsive to the search query;
identify, by a category display module, a list of dominant categories based on the product records identified by the search engine module;
identify, by the category display module, a number of top-level categories associated with the list of dominant categories;
construct, by the category display module, a modified hierarchy of categories based on the number of top-level categories identified;
transmit, by the category display module, the modified hierarchy to the website hosting module; and
display, by the website hosting module, the modified hierarchy in a navigation portion of the webpage, wherein the modified hierarchy is usable to filter the list of product records responsive to the search query.

18. The non-transitory computer-readable medium of claim 17, wherein the instructions, when executed by the processor, cause the processor to identify, using a category display module, at least one sibling category of a dominant category of the list of dominant categories and promote the at least one sibling category to a dominant category upon a determination that a category score for the at least one sibling category is greater than a predetermined threshold.

19. The non-transitory computer-readable medium of claim 17, wherein the instructions, when executed by the processor, cause the processor to:
determine, using a category display module, that the number of top-level categories associated with the list of dominant categories is greater than a predetermined threshold;
remove from the modified hierarchy all ancestor categories of each dominant category of the list of dominant categories that are positioned between the dominant category and the top-level category of the respective dominant category; and
display, by the website hosting module, a first number of hierarchy levels of the modified hierarchy in the navigation portion of the webpage.

20. The non-transitory computer-readable medium of claim 19, wherein the instructions, when executed by the processor, cause the processor to:
determine, using a category display module, that the number of top-level categories associated with the list of dominant categories is less than or equal to the predetermined threshold;
remove from the modified hierarchy all ancestor categories of each dominant category of the list of dominant categories that are positioned between the dominant category and the top-level category of the respective dominant category;
identify at least one common ancestor category of the dominant categories of the list of dominant categories;
add the at least one common ancestor to the modified hierarchy; and
display, by the website hosting module, a second number of hierarchy levels of the modified hierarchy in the navigation portion of the webpage, wherein the second number of hierarchy levels is different than the first number of hierarchy levels.
